(19) United States
(12) Patent Application Publication
(10) Pub. No.: US 2007/0218908 A1
(43) Pub. Date: Sep. 20, 2007

(54) Apparatus and method for supporting optimum network reentry procedure in multihop relay broadband wireless access (BWA) communication system

(75) Inventors: Hyun-Jeong Kang, Seoul (KR); Jung-Je Son, Seongnam-si (KR); Hyoung-Kyu Lim, Seoul (KR); Yeong-Moon Son, Anyang-si (KR); Sung-Jin Lee, Seoul (KR); Joon-Young Choi, Suwon-si (KR); Pan-Yuh Joo, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD, Suwon-si (KR)

(21) Appl. No.: 11/714,698

(22) Filed: Mar. 6, 2007

(30) Foreign Application Priority Data
Mar. 6, 2006 (KR) 2006-0020844

(51) Int. Cl. H04Q 7/20; H04B 3/36

(52) U.S. Cl. 455/442

(57) ABSTRACT

An apparatus and method for supporting an optimized network reentry procedure in a multihop relay Broadband Wireless Access (BWA) communication system are provided. The communication method for an RS in a multihop relay cellular communication system, includes receiving a HO-notify message, which contains information of an MS handed over to the RS, from a Base Station (BS); and performing an optimized network reentry procedure with the MS using the MS information of the HO-notify message. By defining the RS-BS signaling to provide the RS with information as to the MS handed over to the RS, the optimized network reentry procedure can be carried out between the RS being the target node and the MS.

### PRIORITY

This application claims priority under 35 U.S.C. §119 to an application filed in the Korean Intellectual Property Office on Mar. 6, 2006 and assigned Serial No. 2006-20844, the contents of which are incorporated herein by reference.

### BACKGROUND OF THE INVENTION

1. Field of the Invention

The present invention relates generally to a multihop relay Broadband Wireless Access (BWA) communication system, and in particular, to an apparatus and method for supporting an optimum network reentry procedure of a Mobile Station (MS) being handed over in a multihop relay BWA communication system.

2. Description of the Related Art

Research to provide users with various Quality of Service (QoS) at a data rate of over 100 Mbps was an objective aimed at for the fourth generation (4G) communication systems. Specifically, research into the high rate support service to guarantee mobility and QoS in Broadband Wireless Access (BWA) communication systems, such as Local Area Networks (LAN) and Metropolitan Area Networks (MAN), has been under way. Representative examples of the BWA communication system include Institute of Electrical and Electronics Engineers (IEEE) 802.16d and 802.16e communication systems.

IEEE 802.16d and 802.16e communication systems adapt an Orthogonal Frequency Division Multiplexing (OFDM)/Orthogonal Frequency Division Multiple Access (OFDMA) scheme for physical channels. The IEEE 802.16d communication system addresses the stationary or fixed Subscriber Station (SS); that is, IEEE 802.16d communication system does not take into account the mobility of the SS but the single cell structure. By contrast, IEEE 802.16e communication system addresses the mobility of the SS, which is updated from IEEE 802.16d communication system. The mobile SS is referred to as a Mobile Station (MS).

FIG. 1 shows a general IEEE 802.16e communication system.

The IEEE 802.16e communication system of FIG. 1 has a multi cell architecture, that is, a cell 100 and a cell 150. The IEEE 802.16e communication system includes a Base Station (BS) 110 managing cell 100, a BS 140 managing cell 150, and a plurality of MSs 111, 113, 130, 151, and 153. Signals are transmitted and received between BSs 110 and 140 and MSs 111, 113, 130, 151, and 153 using an OFDM/OFDMA scheme. Of MSs 111, 113, 130, 151, and 153, MS 130 resides in the overlapping area of cell 100 and cell 150; that is, in a handover region. When MS 130 migrates to cell 150 managed by BS 140 while transmitting and receiving signals to and from BS 110, the serving BS of MS 130 is changed from BS 110 to BS 140.

By signaling through the direct links between the fixed BS and the MSs as shown in FIG. 1, the general IEEE 802.16e communication system can easily configure highly reliable wireless communication links between the BS and the MSs. However, since the position of the BS is fixed, the IEEE 802.16e communication system is subject to low flexibility in the radio network configuration. Thus, it is hard to provide efficient communication services under a radio communication environment suffering severe changes of traffic distribution or traffic demand.

To overcome these shortcomings, a data delivery scheme using a multihop relay with a fixed relay station, a mobile relay station, or general MSs is applied to a general cellular wireless communication system, such as an IEEE 802.16e communication system. A wireless communication system using a multihop relay scheme can reconfigure the network by promptly coping with the changes of the communication environment and utilize the entire radio network more efficiently. For instance, a multihop relay wireless communication system is able to expand the cell service area and increase the system capacity. In detail, under poor channel conditions between a BS and an MS, better radio channel status can be provided to the MS by installing a relay station between the BS and the MS and establishing a multihop relay path via the relay station. Also, by adopting a multihop relay scheme in a cell boundary of a poor channel status from the BS, a high speed data channel can be provided and the cell service area can be expanded.

Hereinafter, descriptions are provided on the structure of a multihop relay wireless communication system for expanding the service area of a BS.

FIG. 2 shows a multihop relay broadband wireless communication system for extending the service area of the BS.

The multihop relay wireless communication system in FIG. 2 has a multicell architecture, that is, a cell 200 and a cell 240. The multihop relay wireless communication system includes a BS 210 managing cell 200, a BS 250 managing cell 240, MSs 211 and 213 located in cell 200, MSs 221 and 223 managed by BS 210 but located in an area 230 out of cell 200, a relay station 220 providing multihop relay paths between BS 210 and MSs 221 and 223 in area 230, MSs 251, 253 and 255 located in cell 240, MSs 261 and 263 managed by BS 250 but located in an area 270 out of cell 240, and a relay station 260 providing multihop relay paths between BS 250 and MSs 261 and 263 in area 270. Signals are transmitted and received among BSs 210 and 250, relay stations 220 and 260, and MSs 211, 213, 221, 223, 251, 253, 261, and 263 using an OFDM/OFDMA scheme.

MSs 211 and 213 and relay station 220, which belong to cell 200, can transmit and receive signals directly to and from BS 210, whereas MSs 221 and 223 in the area 230 can not transmit and receive signals directly to and from BS 210. Hence, relay station 220 manages area 230 and relays signals between BS 210 and MSs 221 and 223 which are incapable of transceiving signals directly. MSs 221 and 223 can transceive signals with BS 210 via relay station 220. Likewise, MSs 251, 253 and 255 and relay station 260, which belong to cell 240, can transmit and receive signals directly to and from BS 250, whereas MSs 261 and 263 in area 270 can not transmit and receive signals directly to and from BS 250. Hence, relay station 260 manages area 270 and relays signals between BS 250 and MSs 261 and 263 which are incapable of transceiving signals directly. MSs 261 and 263 can transmit and receive signals to and from BS 250 via relay station 260.

Now, a structure of a multihop relay wireless communication system for increasing the system capacity is illustrated.

FIG. 3 shows a broadband wireless communication system using a multihop relay scheme for increasing the system capacity.

The multihop relay wireless communication system in FIG. 3 includes a BS 310, MSs 311, 313, 321, 323, 331 and 333, and relay stations 320 and 330. Relay stations 320 and 330 provide multihop relay paths between BS 310 and MSs 311, 313, 321, 323, 331 and 333. Signals are transmitted and received among BS 310, relay stations 320 and 330, and MSs 311, 313, 321, 323, 331 and 333 according to the OFDM/OFDMA scheme. BS 310 manages a cell 300. MSs 311, 313, 321, 323, 331 and 333 and relay stations 320 and 330, belonging to cell 300, are capable of transmitting and receiving signals directly to and from BS 310.

However, when some MSs 321, 323, 331 and 333 reside close to the boundary of cell 300, the Signal-to-Noise Ratio (SNR) of the direct links between BS 310 and some MSs 321, 323, 331 and 333 may be lower. Thus, relay station 320 relays the unicast traffics of BS 310 and MSs 321 and 323, and MSs 321 and 323 transmit and receive the unicast traffics to and from BS 310 via relay station 320. Likewise, relay station 330 relays the unicast traffics of BS 310 and MSs 331 and 333, and MSs 331 and 333 transmit and receive the unicast traffics to and from BS 310 via relay station 330. That is, relay stations 320 and 330 raise the effective data rate of the MSs and increase the system capacity by providing high-speed data delivery paths to MSs 321, 323, 331 and 333.

In a multihop relay broadband wireless communication system of FIG. 2 or 3, relay stations 220, 260, 320 and 330 may be infrastructure relay stations which are installed by a service provider and already known to BSs 210, 250 and 310 for management, or client relay stations which serve as subscriber stations (e.g., SSs or MSs) in some cases and relay stations in other cases. The relay stations 220, 260, 320 and 330 may be fixed relay stations, nomadic relay stations (e.g., notebook computers), or mobile relay stations such as MSs.

In the multihop relay wireless communication system as above, when communicating with a BS or an RS, an MS may be handed over from the service area of the BS or the RS to another BS or RS. In the handover, the MS resumes communications with a target node by performing a network reentry procedure with a BS corresponding to the target node or another RS.

FIG. 4 shows a network reentry procedure between an MS and a target node in a general broadband wireless communication system.

In FIG. 4, MS 410 being handed over synchronizes with target node 450 by receiving a preamble of target node 450 in step 411. MS 410 obtains information required for the ranging by receiving Downlink Channel Descriptor (DCD), Uplink Channel Descriptor (UCD), DL-MAP, and UL-MAP messages of target node 450, and performs the ranging using the acquired information in step 413. The UCD message contains a handover ranging code set allocated for the handed MS. Accordingly, MS 410 attempts the ranging by selecting a random code of the handover ranging code set contained in the UCD message and transmitting the selected handover ranging code to target node 450 over a ranging opportunity interval

Upon the completion of the ranging procedure, MS 410 carries out a basic capability negotiation procedure with the target node in step 415. In doing so, MS 410 and target node 450 exchange MS basic information required for the communication by exchanging SS Basic Capability Negotiation Request (SBC-REQ) and SS Basic Capability Response (SBC-RSP) messages. Next, in step 417, MS 410 executes an authentication procedure for authentication and encryption key generation for target node 450. MS 410 registers to target node 450 by exchanging Registration Request (REG-REQ) and Registration Response (REG-RSP) messages with target node 450 in step 419. After finishing the network reentry procedure required to continue the communications after the handover, MS 410 and target node 450 perform the normal communication procedure.

As discussed above, the handed MS is able to normally communicate via the target node only after the network reentry procedure of FIG. 4 is completed. Hence, to promptly resume communication, the handed MS should execute the network reentry procedure quickly.

To support the fast network reentry procedure of the handed MS, the basic capability negotiation procedure, the authentication procedure, and the registration procedure can be omitted. For doing so, what is needed is a method for reducing signaling exchanges between the MS and the target node by providing the target node in advance with information that enables it to omit the basic capability negotiation procedure, the authentication procedure, and the registration procedure. Particularly, when the target node is an RS, the signaling procedure should be defined between the RS and the BS to provide the MS information to the RS. Also, if the target node requires additional MS information, an RS-BS signaling procedure for requesting the additional information should be defined.

### SUMMARY OF THE INVENTION

An aspect of the present invention is to substantially solve at least the above problems and/or disadvantages and to provide at least the advantages below. Accordingly, an aspect of the present invention is to provide an apparatus and method for supporting the optimized network reentry procedure of a Mobile Station (MS), which is handed over in a multihop relay Broadband Wireless Access (BWA) communication system.

Another aspect of the present invention is to provide an apparatus and method for providing a target node with information required for an optimized network reentry procedure of an MS being handed over in a multihop relay BWA communication system.

A further aspect of the present invention is to provide an apparatus and method for supporting an optimized network reentry procedure to promptly resume MS's communication when handover of the MS is not recognized in advance in a multihop relay BWA communication system.

The above aspects are achieved by providing a communication method for an RS in a multihop relay cellular communication system, which includes receiving a HO-notify message, which contains information of an MS handed over to the RS, from a Base Station (BS); and performing an optimized network reentry procedure with the MS using the MS information of the HO-notify message.

According to one aspect of the present invention, a communication method for an RS in a multihop relay cellular communication system, includes determining whether the former serving node is the RS, when receiving a ranging request message containing a former serving node identifier (ID) from an MS; when the former serving node is not the RS, sending a request message to a BS, which requests MS information; receiving a response message including the requested MS information from the BS; and performing an optimized network reentry procedure with the MS using the MS information of the response message.

According to another aspect of the present invention, a communication method for a BS in a multihop relay cellular communication system, includes determining whether a target node is an RS managed by the BS when receiving a MOB_HO-IND message indicating handover of an MS; and when the target node is the RS managed by the BS, sending a HO-notify message containing information required for a network reentry procedure of the MS, to the RS.

According to a further aspect of the present invention, a communication method for a BS in a multihop relay cellular communication system, includes determining whether a target node is the BS when receiving a HO-confirm message containing information of a handed MS from an adjacent BS; and when the target node is an RS managed by the BS, sending to the RS a HO-notify message containing information required for a network reentry procedure of the MS.

According to still another aspect of the present invention, a communication method for a BS in a multihop relay cellular communication system, includes determining whether the former serving node is a node managed by the BS when receiving a ranging request message including a former serving node ID from an MS; when the former serving node is not the node managed by the BS, transmitting or broadcasting to an adjacent BS or adjacent BSs a request backbone message which requests the MS information; receiving from the adjacent BS a response backbone message including the requested MS information; and performing an optimized network reentry procedure with the MS using the information of the response backbone message.

According to a further aspect of the present invention, an RS in a multihop relay cellular system, includes a message processor which, when a HO-notify message is received from a BS, extracts information of a handed MS from the HO-notify message; and a controller, which performs an optimized network reentry procedure with the MS using the information extracted from the HO-notify message.

According to yet another aspect of the present invention, a communication method for a BS in a multihop relay cellular communication system, includes determining whether a target node is an RS managed by the BS when receiving a message indicating handover of an MS; when the target node is the RS, generating a handover control message which contains ranging interval allocation time information of the target node; and transmitting the handover control message to the RS.

### BRIEF DESCRIPTION OF THE DRAWINGS

The above and other objects, features and advantages of the present invention will become more apparent from the following detailed description when taken in conjunction with the accompanying drawings in which:

FIG. 1 is a system overview of a general IEEE 802.16 communication system;

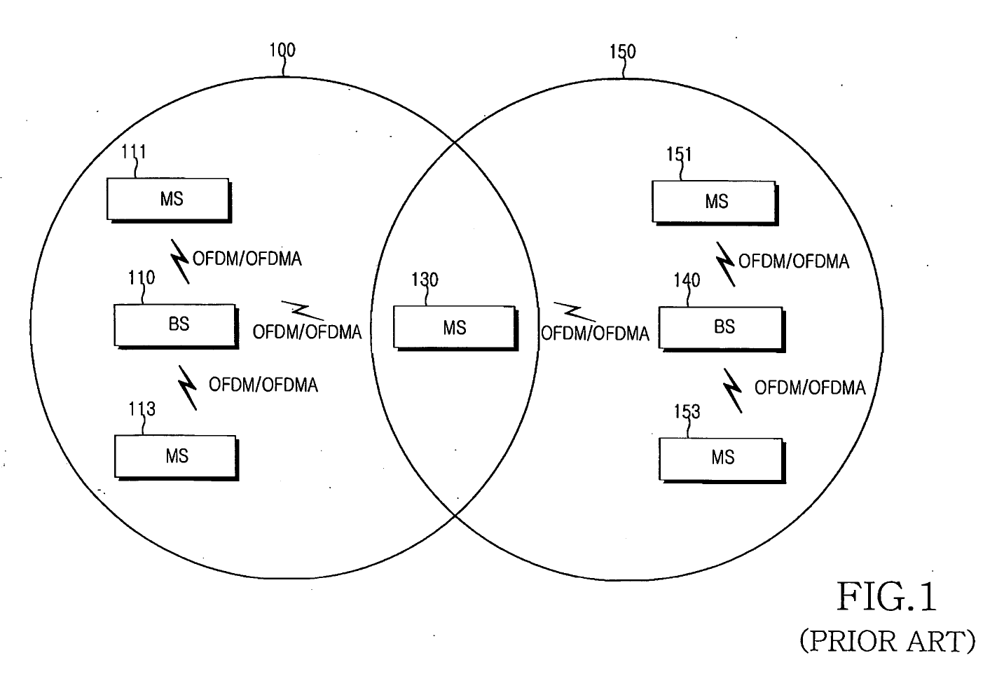

FIG. 2 is a system overview of a multihop relay broadband wireless communication system to expand a service area of a BS;

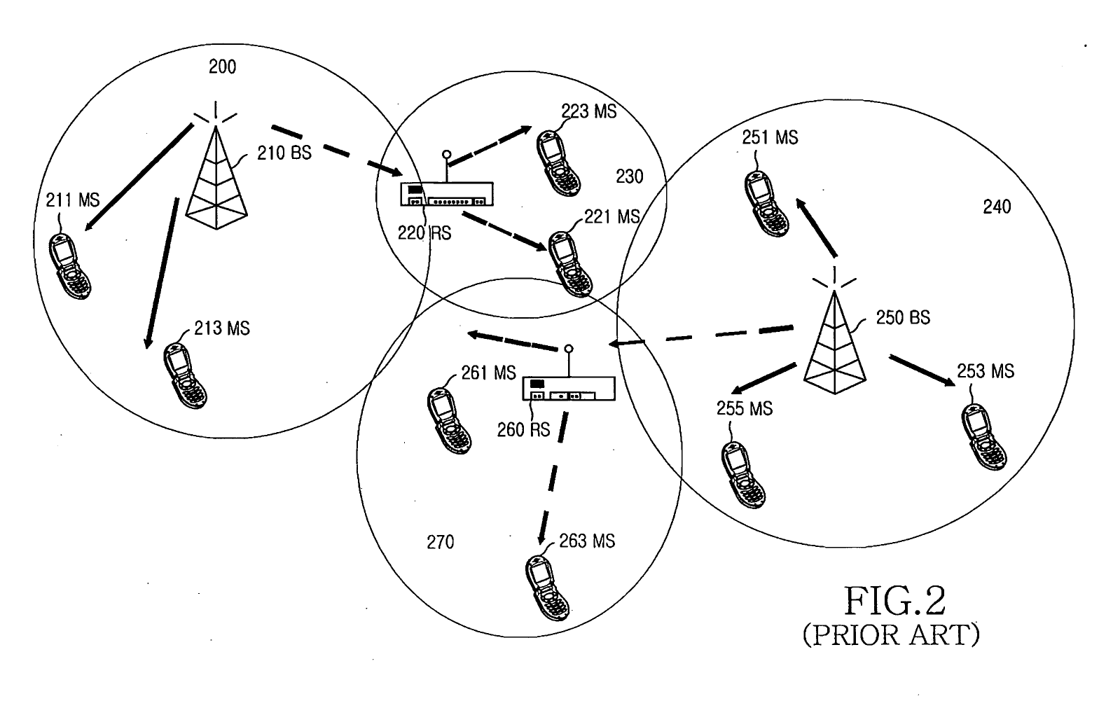

FIG. 3 is a system overview of a multihop relay broadband wireless communication system to increase system capacity;

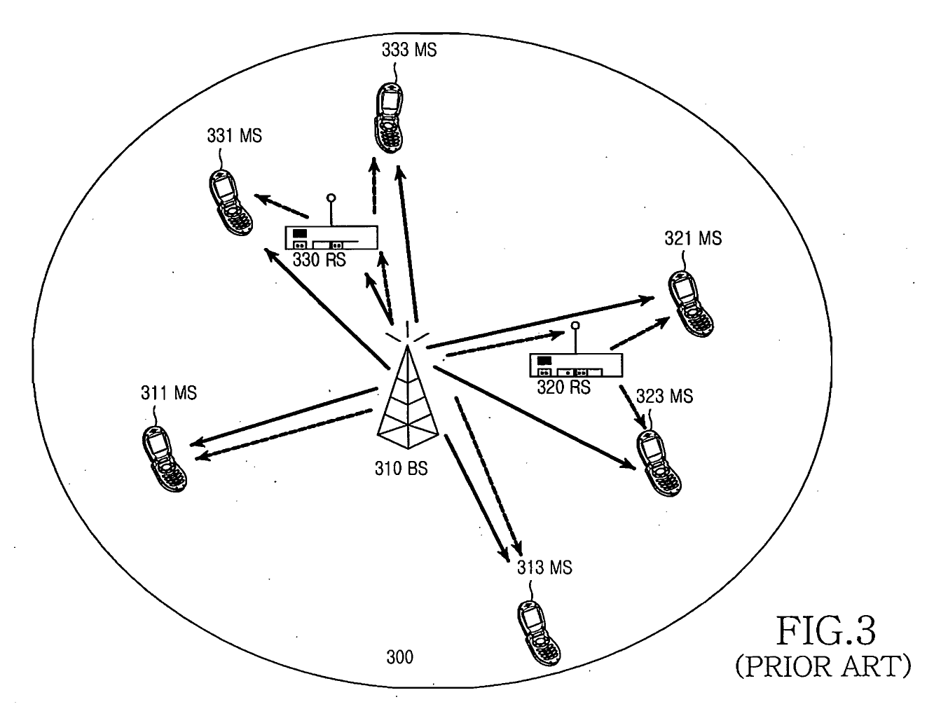

FIG. 4 depicts a network reentry procedure between an MS and a target node in a general broadband wireless communication system;

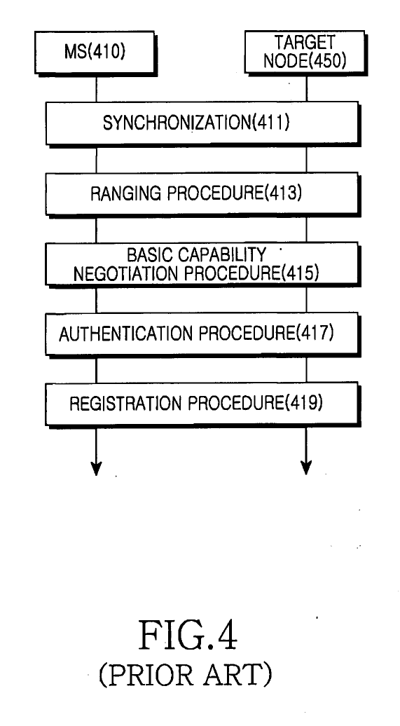

FIG. 5 is a flow chart for operations of a serving BS, which provides a target node with information relating to a handed MS in a multihop relay broadband wireless communication system according to the present invention;

FIG. 6 is a flow chart for operations of an adjacent BS, which receives MS information from a serving BS in the broadband wireless communication system according to the present invention;

FIG. 7 is a flow chart for operations of an RS, as a target node, which receives MS information in the broadband wireless communication system according to the present invention;

FIG. 8 is a flow chart for operations of a BS, which receives an MS information request from the RS in the broadband wireless communication system according to the present invention;

FIG. 9 is a flow chart for operations of an RS, which requests information relating to the MS, which attempts to reenter the network in the broadband wireless communication system according to the present invention;

FIG. 10 is a flow chart for operations of a BS which requests information relating to the MS attempting to reenter the network to a former serving node in the broadband wireless communication system according to the present invention; and

FIG. 11 is a block diagram of a BS (or RS) according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides a signaling procedure for supporting an optimized network reentry of a Mobile Station (MS) handed over in a multihop relay Broadband Wireless Access (BWA) communication system. The optimized network reentry procedure omits part of the basic capability negotiation procedure, an authentication procedure, and a registration procedure using MS information acquired in advance.

The multihop relay BWA communication system is an Orthogonal Frequency Division Multiplexing (OFDM) or Orthogonal Frequency Division Multiple Access (OFDMA) communication system. The multihop relay BWA communication system, which adopts the OFDM/OFDMA scheme, enables high speed data delivery by transmitting physical channel signals using a plurality of subcarriers and supports mobility of MS by means of a multicell architecture.

While the BWA communication system is illustrated by way of example, the present invention is also applicable to multihop relay cellular communication systems.

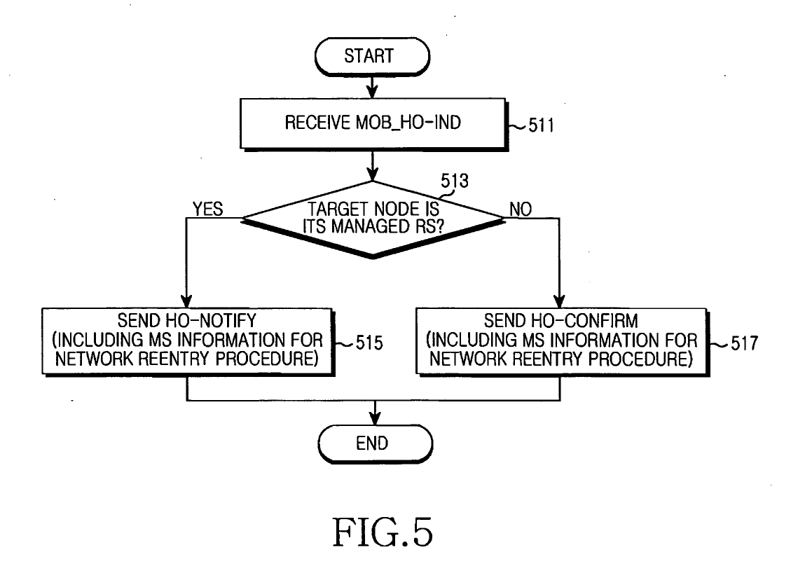

Referring to FIG. 5, the serving BS receives a MOB_HO-IND message, which informs handover of an MS managed by the serving BS in step 511. The MOB_HO-IND message contains information relating to a target node to which the MS is handed over, and is received directly from the MS or via a serving node (serving RS) of the MS.

Upon receiving the MOB_HO-IND message, the serving BS determines if the MS's target node is an RS in its service area (cell) in step 513. When the target node is the RS governed by the serving BS, the serving BS sends a HO-notify message, which notifies of the MS handover, to the RS in step 515. The HO-notify message may contain information as shown in Table 1.

TABLE 1

| MS ID | Variables | MS's identifier |
|---|---|---|
| CID information | Variables | MS's connection identifiers |
| MS basic capability | Variables | MS's subscriber basic capability |
| information | | information |
| MS security | Variables | MS's authentication/authorization |
| information | | information |
| MS registration | Variables | MS's registration information |
| information | | |

In Table 1, the HO-notify message may contain identifier (ID) information of MS which is handed over, basic Connection Identifier (CID) and primary management CID information to be used by the MS at the target node, MS basic capability information supported by the MS, MS security information, and information required for the MS's registration (MS registration information). The basic CID and primary management CID information of Table 1 may be delivered when the BS manages IDs of its RSs and MSs. Besides the information arranged in Table 1, the HO-notify message may contain other information required to support the optimized network reentry procedure.

For instance, the other information may include ranging interval allocation time information, which indicates a transmission of a fast ranging Information Element (IE), which allocates a contention-free ranging interval. The ranging interval allocation time reflects action time information provided by the BS when the MS exchanges a handover control message with the BS. The action time corresponds to a standby time from the MS's handover until the fast ranging IE, which allocates the contention-free ranging interval, is received from the target node. That is, when an RS corresponding to the target node performs a distributed scheduling, the RS needs to transmit the fast ranging IE (or allocate the contention-free ranging interval) in the action time known to the MS. Hence, the BS should provide the target node with the ranging interval allocation time information which reflects the action time.

When the target node in the MOB_HO-IND message is not an RS managed by the BS; that is, when the target node is an adjacent BS or an RS managed by the adjacent BS, the serving BS sends a HO-confirm message, which indicates the MS handover, to the adjacent BS managing the target node in step 517.

The HO-confirm message may contain information as shown in Table 2.

TABLE 2

| Target node ID | Variables | Target node's identifier |
|---|---|---|
| MS ID | Variables | MS's identifier |
| MS basic capability | Variables | MS's subscriber basic |
| information | | capability information |
| MS security | Variables | MS's authentication/authorization |
| information | | information |
| MS registration | Variables | MS's registration information |
| information | | |

In Table 2, the HO-confirm message may contain ID information of the target node to which the MS is handed over (Target node ID), ID information of the handed MS (MS ID), basic capability information supported by the MS (MS basic capability information), MS security information, and information required for the MS's registration (MS registration information). The information of Table 2 can be used for the optimized network reentry procedure between the MS, which is handed over to the coverage of the adjacent BS and the target node in the coverage of the adjacent BS. Besides the above information of Table 2, the HO-confirm message may contain other information required to support the optimized network reentry procedure. For instance, the other information can contain the ranging interval allocation time information that reflects a standby action time until the MS receives the fast ranging IE from the target node belonging to the coverage of the adjacent BS.

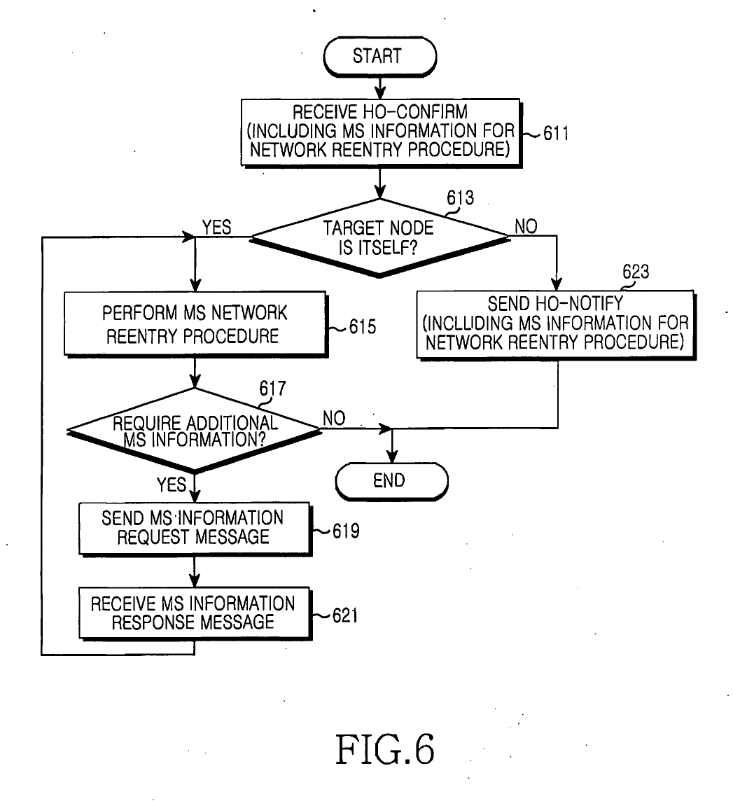

Referring to FIG. 6, the adjacent BS receives the HO-confirm message from the serving BS of the handed MS in step 611. The HO-confirm message informs the MS's handover to the coverage of the adjacent BS. The HO-confirm message can contain the information of Table 2 and the ranging interval allocation time information. Upon receiving the HO-confirm message, the adjacent BS determines whether itself is a MS's target node in step 613.

When the adjacent BS is the MS's target node, the adjacent BS performs the network reentry procedure with the MS in step 615. The adjacent BS carries out the optimized network reentry procedure with the MS by taking advantage of the information (Table 2) contained in the received HO-confirm message.

During the optimized network reentry procedure, it determines whether additional MS information is required for the network reentry procedure in step 617. When the additional MS information is required, the adjacent BS generates an MS information request backbone message to request the additional information and sends the generated message to the serving BS in step 619.

The MS information request backbone message can be constructed as shown in Table 3.

TABLE 3

| MS information request | | |
|---|---|---|
| message format( ) { | Size (bits) | Notes |
| MS ID | Variables | MS's identifier |
| MS basic capability info | Variables | Request on MS's subscriber |
| request | | basic capability information |
| MS security info request | Variables | Request on MS's |
| | | authentication/authorization |
| | | information |
| MS registration info | Variables | Request on MS's registration |
| request | | information |
| } | | |

The MS information request backbone message of Table 3 may contain MS ID information and request information for the MS information to be provided to the adjacent BS. Namely, if requiring information for the basic capability negotiation procedure, basic capability information request information (MS basic capability info request) is found in the MS information request backbone message. When requiring information for the authentication procedure, authentication information request information (MS security info request) is found in the MS information request backbone message. When requiring information for the registration procedure, registration information request information (MS registration info request) is also found in the MS information request backbone message.

After sending the MS information request backbone message, the adjacent BS checks if the MS information response backbone message is received from the serving BS in step 621. When the MS information response backbone message is received, the adjacent BS returns to step 615 to continue the network reentry procedure with the MS using the information of the MS information backbone message.

The MS information response backbone message can be constructed as shown in Table 4.

TABLE 4

| MS information response | | |
|---|---|---|
| message format( ) { | Size (bits) | Notes |
| MS ID | Variables | MS's identifier |
| MS basic capability | Variables | MS's subscriber basic |
| info | | capability information |
| MS security info | Variables | MS's authentication/authorization |
| | | information |
| MS registration info | Variables | MS's registration information |
| } | | |

As shown in Table 4, the MS information response message can contain ID information of the handed MS (MS ID) and the MS information requested by the adjacent BS. Specifically, the MS information response message can contain information required for the basic capability negotiation procedure with the MS (MS basic capability info), information required for the authentication procedure with the MS (MS security info), and information required for the registration procedure with the MS (MS registration info). The MS information request backbone message of Table 3 and the MS information response backbone message of Table 4 are exchanged between the BSs over the backbone network, and may contain other information than the above information for the optimized network reentry procedure.

When the additional MS information is not necessary in step 617, the adjacent BS finishes the optimized reentry procedure. Next, the adjacent BS and the MS resume normal communication.

By contrast, when the target node is an RS managed by the adjacent BS in step 613, the adjacent BS sends to the RS a HO-notify message indicating the MS's handover in step 623. The HO-notify message may contain the information of Table 1. If the RS corresponding to the target node performs a distributed scheduling, the HO-notify message may contain the ranging interval allocation time information, which informs of the allocation time of the contention-free ranging interval to the MS.

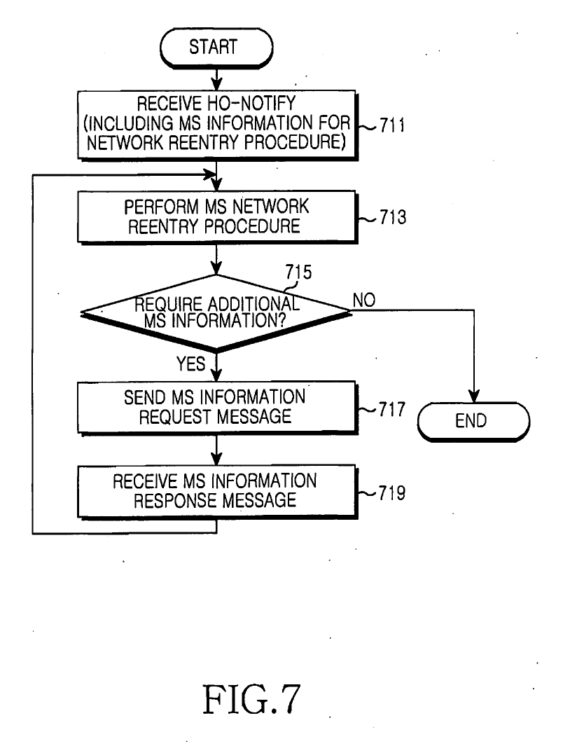

The RS of FIG. 7 receives from its BS a HO-notify message indicating the MS's handover in step 711. The HO-notify message may contain the information of Table 1 and the ranging interval allocation time information. Next, the RS performs the optimized network reentry procedure with the MS using the information contained in the received HO-notify message in step 713.

During the optimized network reentry procedure, the RS determines if additional MS information is required for the network reentry procedure in step 715. When the additional MS information is required, the RS sends to its BS an MS information request message to request the additional information in step 717.

The MS information request message can be constructed as shown in Table 5.

TABLE 5

| MS information request | | |
|---|---|---|
| message format( ) { | Size (bits) | Notes |
| MS ID | Variables | MS's identifier |
| MS basic capability info | Variables | Request on MS's subscriber |
| request | | basic capability information |
| MS security info request | Variables | Request on MS's |
| | | authentication/authorization |
| | | information |
| MS registration info | Variables | Request on MS's registration |
| request | | information |
| } | | |

In Table 5, the MS information request message may contain MS ID information and request information as to the MS information to be provided to the RS. Specifically, when information for the basic capability negotiation procedure is required, basic capability information request information (MS basic capability info request) is included. When information for the authentication procedure is necessary, authentication information request information (MS security info request) is included. Otherwise, when information for the registration procedure is required, registration information request information (MS registration info request) is included. As mentioned earlier, the message of Table 3 and the message of Table 5 may contain the same information. The difference lies in that the message of Table 3 is a backbone message exchanged between the BSs and the message of Table 5 is a radio message exchanged between the BS and the RS.

After sending the MS information request message, the RS checks if an MS information response message is received from its BS in step 719. When receiving the MS information response message, the RS returns to step 713 to continue the network reentry procedure with the MS using the information of the MS information response message.

The MS information response message can be constructed as shown in Table 6.

TABLE 6

| MS information response | | |
|---|---|---|
| message format( ) { | Size (bits) | Notes |
| MS ID | Variables | MS's identifier |
| MS basic capability info | Variables | MS's subscriber basic |
| | | capability information |
| MS security info | Variables | MS's authentication/authorization |
| | | information |
| MS registration info | Variables | MS's registration information |
| } | | |

In Table 6, the MS information response message may contain ID information of the handed MS (MS ID) and the MS information requested by the RS. Specifically, the MS information response message may contain information required for the basic capability negotiation procedure with the MS (MS basic capability info), information required for the authentication procedure with the MS (MS security info), and information required for the registration procedure with the MS (MS registration info). The MS information request message of Table 5 and the MS information response message of Table 6 may convey other information than the above information of Table 5 and Table 6 for the sake of the optimized network reentry procedure.

By contrast, when additional MS information is not needed in step 715, the RS finishes the optimized network reentry procedure. Afterwards, the RS and the MS resume normal communications.

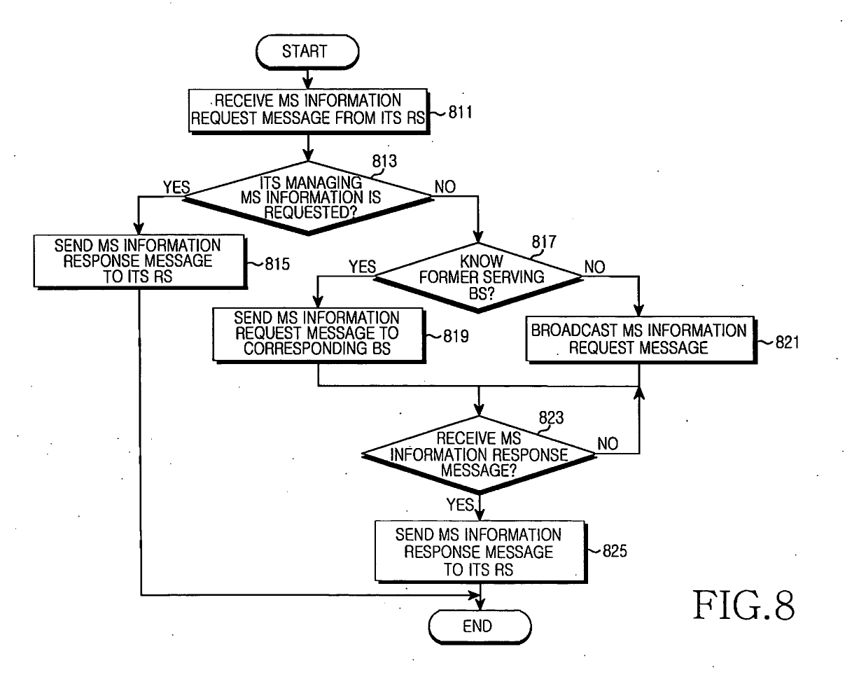

In FIG. 8, the BS receives the MS information request message (Table 5) from its managing RS in step 811. Upon receiving the MS information request message, the BS checks if the RS requests information relating to an MS managed by the BS in step 813. When the information of the MS managed by the BS is requested, the BS generates an MS information response message (Table 6) containing the requested MS information and sends the generated message to the RS in step 815. When the information of the MS managed by the BS is not requested; that is, when the BS does not govern the MS, the BS determines if it knows an adjacent BS managing the MS in step 817.

When confirming the adjacent BS managing the MS, the BS transmits the MS information request backbone message (Table 3) requesting the MS information to the adjacent BS in step 819 and then proceeds to step 823. In contrast, when not confirming the adjacent BS managing the MS, the BS broadcasts the MS information request backbone message (Table 3) requesting the MS information to adjacent BSs in step 821 and then proceeds to step 823. If there exists a specific system managing the entire network, the BS sends the MS information request message (Table 3) to the specific system and then proceeds to step 823.

In step 823, the BS checks if the MS information response backbone message (Table 4) including the requested MS information is received from the adjacent BS in step 823. When receiving the MS information response backbone message, the BS generates the MS information response message (Table 6) containing the information of the MS information response backbone message and sends the generated message to the RS in step 825.

FIGS. 5 through 8 illustrate the RS-BS signaling procedure to provide the MS information to the RS, which is the target node when the MS is handed over to the RS. In this signaling procedure, the BS managing the MS can transmit the HO-notify message including the MS information to the target node, and the target node can recognize the MS's handover and acquire the MS information in advance.

However, without recognizing the MS's handover, the target node may perform the network reentry procedure with the MS by receiving the ranging request message together with a former serving node ID from the MS. For instance, during the handover negotiation between the MS and the serving node, if the MS is dropped before the serving node receives the MOB_HO-IND message, the MS may attempt the reconnection to another node or its former serving node. In this case, the other node can request the MS information from the former serving node of the MS.

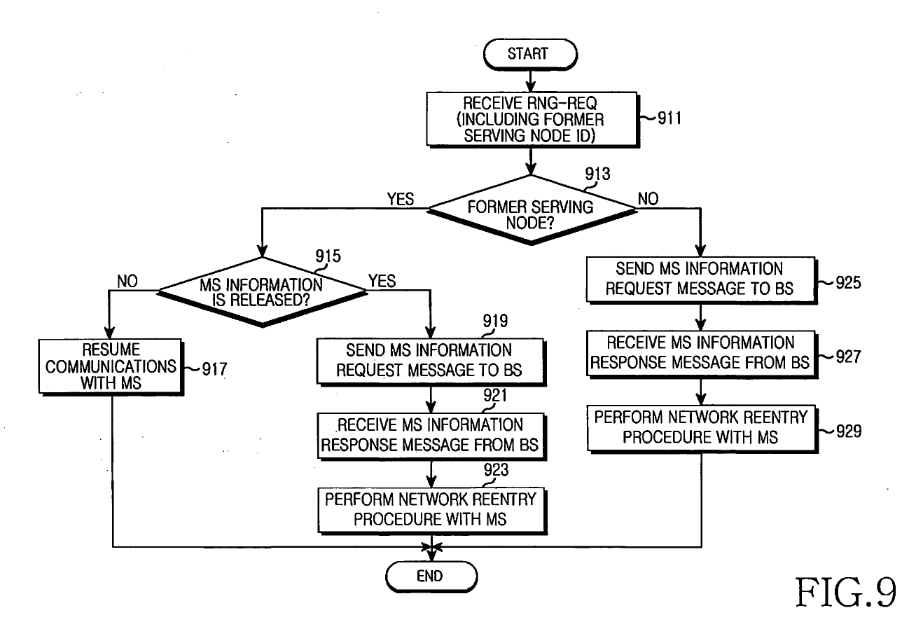

The RS of FIG. 9 receives a ranging request (RNG-REQ) message containing the former serving node ID from the MS in step 911. Upon receiving the RNG-REQ message, the RS determines if the former serving node ID designates itself in step 913.

When the former serving node is the RS, the RS determines if the MS information is released in step 915. A general mobile communication system may decide to hold information as to the handed MS in a former serving cell for a preset time. If the RS holds the MS information, it resumes normal communication with the MS based on the MS information in step 917.

If the MS information is released, the RS generates an MS information request message (Table 5) requesting the MS information and sends the generated message to its BS in step 919. Next, the RS receives an MS information response message (Table 6) including the MS information from the BS in step 921 and carries out the optimized network reentry procedure with the MS using the received MS information in step 923.

By contrast, when the RS is not the former serving node of the MS in step 913, it generates an MS information request message (Table 5) requesting the MS information and sends the generated message to the BS in step 925. At this time, the MS information request message contains the former serving node ID information of the RNG-REQ message received from the MS in addition to the information of Table 5.

Next, the RS receives an MS information response message (Table 6) including the MS information from the BS in step 927, and carries out the optimized network reentry procedure with the MS using the received MS information in step 929.

Meanwhile, note that the MS information response message (Table 6) received in step 921 or step 927 may contain MS's basic CID and primary management CID information in case where the BS manages IDs of MSs and RSs.

Note that the BS, which receives the MS information request message (Table 5) from the RS in step 919 or step 925, operates the same as in FIG. 8.

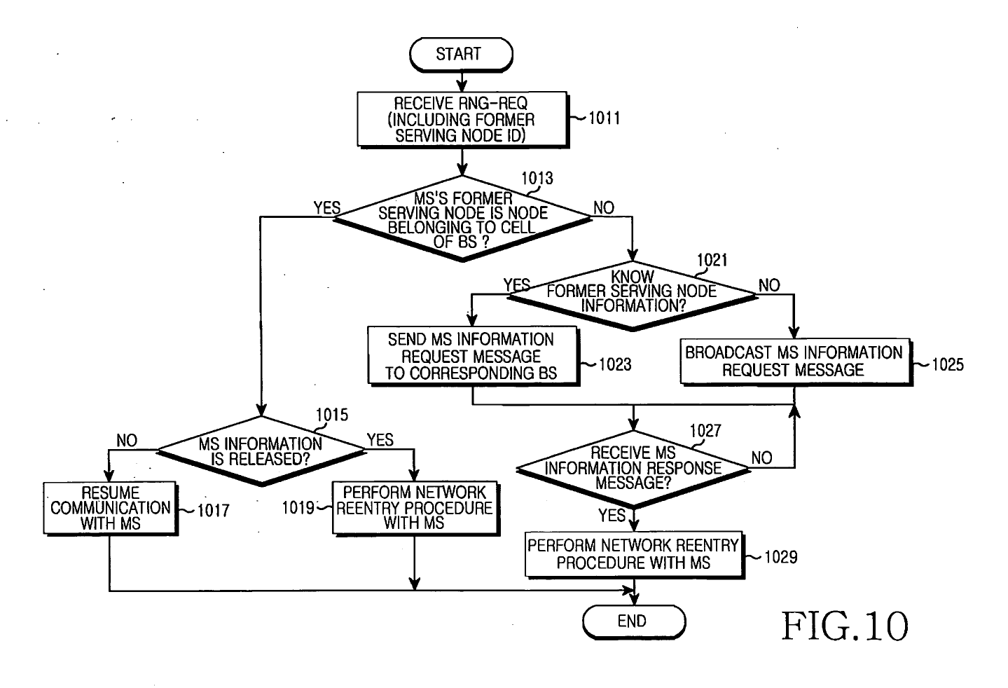

The BS of FIG. 10 receives a RNG-REQ message including the former serving node ID information from the MS in step 1011. Upon receiving the RNG-REQ message, the BS determines if the MS's former serving node is a node (including BS) belonging to the cell of the BS in step 1013.

When the former serving node is a node managed by the BS, the BS determines if information relating to the MS is released in step 1015. A general mobile communication system may decide to hold the information as to the handed MS in the former serving cell over a certain time. If holding the MS information, the BS resumes normal communications with the MS based on the MS information in step 1017. If the MS information is released, the BS performs the network reentry procedure with the MS in step 1019.

By contrast, when the former serving node is not a node managed by the BS in step 1013, the BS determines if it knows an adjacent BS managing the former serving node in step 1021. When confirming the adjacent BS managing the former serving node, the BS generates an MS information request backbone message (Table 3) requesting the MS information and sends the generated message to the adjacent BS in step 1023, and then proceeds to step 1027. At this time, the MS information request backbone message contains the former serving node ID information of the RNG-REQ message received from the MS, besides the information of Table 3.

When not confirming an adjacent BS managing the former serving node, the BS broadcasts an MS information request backbone message requesting the MS information to adjacent BS in step 1025 and then proceeds to step 1027. If there exists a specific system managing the entire network, the BS transmits the MS information request backbone message (Table 3) to the specific system and then goes to step 1027.

Next, the BS checks if the MS information response backbone message (Table 4) including the requested MS information is received from the adjacent BS in step 1027. Upon receiving the MS information response backbone message, the BS carries out the optimized network reentry procedure with the MS using information of the MS information response backbone message in step 1029.

In the mean time, when the RS supports the distributed scheduling, the BS managing the RS may exchange the ranging interval allocation time information with the RS in advance when exchanging the handover control message with the MS in order to provide the action time to the MS handed over to the RS. In this case, when the BS is not a serving BS, the BS provides the serving BS with the ranging interval allocation time information acquired from the RS. The serving BS determines an action time for the MS based on the ranging interval allocation time information acquired from the adjacent BS and the RS managed by the serving BS. The serving BS can provide the action time information to an RS corresponding to the candidate target node or the adjacent BS in advance. Alternatively, as described above, receiving a MOB_HO-IND message indicating the final handover from the MS, the serving BS can transmit to the target node a message (HO-notify message, HO-confirm message) including the ranging interval allocation time information, which reflects the action time provided to the MS.

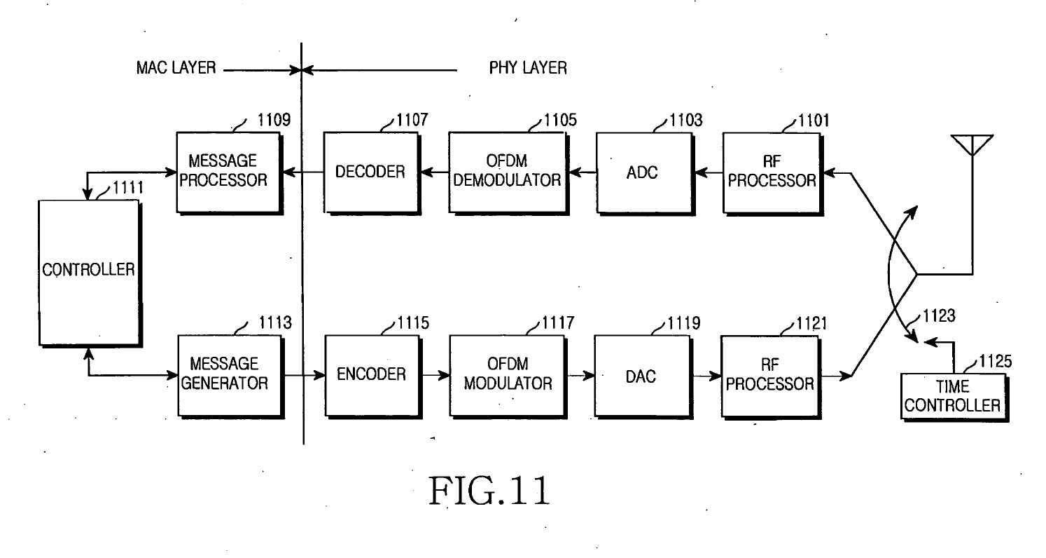

Since the BS and the RS both having the same interface module (communication module) have the same structure, operations of the BS and the RS are now illustrated using the apparatus of FIG. 11. Also, a Time Division Duplex (TDD)-OFDMA system is illustrated by way of example. It should be understood that the present invention is applicable to Frequency Division Duplex (FDD)-OFDMA systems, hybrid systems using both TDD and FDD, and cellular systems adopting other resource allocation schemes.

The BS (or RS) of FIG. 11 includes a Radio Frequency (RF) processor 1101, an analog to digital converter (ADC) 1103, an OFDM demodulator 1105, a decoder 1107, a message processor 1109, a controller 1111, a message generator 1113, an encoder 1115, an OFDM modulator 1117, a digital to analog converter (DAC) 1119, an RF processor 1121, a switch 1123, and a time controller 1125.

Time controller 1125 controls the switching operation of switch 1123 based on time synchronization. For instance, in a signal Rx interval, time controller 1125 controls switch 1123 to connect an antenna to RF processor 1101 of the receiving stage. In a signal transmit (Tx) interval, time controller 1125 controls switch 1123 to connect the antenna to RF processor 1121 of the transmitting stage.

In the receiving (Rx) interval, RF processor 1101 converts an RF signal, which is received through the antenna, to the baseband analog signal. ADC 1103 converts the analog signal fed from RF processor 1101 to sample data. OFDM demodulator 1105 fast Fourier transform processes the sample data fed from ADC 1103 to frequency-domain data, and selects and outputs data of subcarriers to be received substantially from the frequency-domain data.

Decoder 1107 demodulates and decodes the data fed from OFDM demodulator 1105 according to a preset modulation level (MCS level).

Message processor 1109 decomposes a control message from decoder 1107 and provides its result to controller 1111. Controller 1111 processes information fed from message processor 1109. Also, controller 1111 generates and provides information to transmit to message generator 1113. Message generator 1113 generates a message with the various information provided from controller 1111 and outputs the generated message to encoder 1115 of the physical layer.

Encoder 1115 encodes and modulates the data fed from message generator 1113 according to the preset modulation level (MCS level). OFDM modulator 1117 inverse fast Fourier transform processes the data from encoder 1115 and outputs sample data (OFDM symbols). DAC 1119 converts the sample data to an analog signal. RF processor 1121 converts the analog signal fed from DAC 1119 to an RF signal and transmits the RF signal on the antenna.

As constructed above, controller 1111, which is a protocol controller, controls message processor 1109 and message generator 1113. That is, controller 1111 functions as message processor 1109 and message generator 1113. According to the present invention, they are separately provided to distinguish their functions. Hence, in the real implementation, both or part of message processor 1109 and message generator 1113 may be processed at controller 1111.

In addition, controller 1111 provides information required for the protocol execution to a corresponding component of the physical layer, or generates a control signal to a corresponding component of the physical layer.

Now, referring to FIG. 11, operations of the RS and the BS are illustrated respectively. The following explanation focuses on the control message processing in the Media Access Control (MAC) layer.

As for the RS, message processor 1109 decomposes a control message received from an MS or a BS and provides its result to controller 1111. When receiving the HO-notify message (Table 1) including the information required for the optimized network reentry procedure or the MS information response message (Table 6) including the information required for the optimized network reentry procedure, message processor 1109 extracts various control information from the received message and provides the extracted information to controller 1111.

Next, controller 1111 controls to carry out the optimized network reentry procedure with the corresponding MS using the information contained in the HO-notify message or the MS information response message. Namely, controller 1111 controls the message exchange with the MS according to the optimized network reentry procedure. Meanwhile, when additional MS information is necessary during the optimized network reentry procedure, controller 1111 controls message generator 1113 to generate an MS information request message.

Message generator 1113 generates a message destined for the BS under the control of controller 1111, or generates a message destined for the MS managed by the RS and provides the message to the physical layer. According to the present invention, message generator 1113 generates an MS information request message (Table 5) requesting information required for the optimized network reentry procedure with the MS handed over to the RS, and provides the generated message to the physical layer.

The message generated at message generator 1113 is processed to a form transmittable in the physical layer and then transmitted over the antenna.

As for the BS, message processor 1109 decomposes a control message received from an MS or an RS and provides its result to controller 1111. When receiving an MS information request message (Table 5) requesting MS information from the RS, message processor 1109 extracts various control information from the received message and provides the extracted information to controller 1111. Also, message processor 1109 processes a message received over a backbone network (wired). When receiving a HO-confirm message (Table 2) including MS information required for the optimized network reentry procedure, an MS information request backbone message (Table 3) requesting information of the handed MS, or an MS information response backbone message (Table 4) including MS information required for the optimized network reentry procedure from an adjacent BS, message processor 1109 extracts various control information from the received message and provides the extracted information to controller 1111.

Next, controller 1111 acquires the corresponding MS information from a database (not shown) by responding to the MS information request message (Table 5) and provides the acquired information to message generator 1113. Also, controller 1111 executes the optimized network reentry procedure with the corresponding MS using the information contained in the HO-confirm message (Table 2) and the MS information response backbone message (Table 4). Controller 1111 acquires the corresponding MS information by responding to the MS information request backbone message (Table 3) and provides the acquired information to message generator 1113. Meanwhile, when additional MS information is necessary during the optimized network reentry procedure, controller 1111 controls message generator 1113 to generate the MS information request backbone message (Table 3).

Message generator 1113 generates a message destined for an MS or an RS and provides the generated message to the physical layer under the control of controller 1111. According to the present invention, message generator 1113 generates a HO-notify message (Table 1) including information required for the optimized network reentry procedure of the MS handed over to the RS and an MS information response message (Table 6) providing MS information to the RS requesting the MS information, and provides the generated messages to the physical layer. The message generated at message generator 1113 is processed to a form transmittable in the physical layer and then transmitted over the antenna.

Message generator 1113 generates a message, which is transmitted to an adjacent BS over the backbone network. Message generator 1113 generates a HO-confirm message (Table 2) including information necessary for the optimized network reentry procedure of the MS handed over to an adjacent cell, an MS information request backbone message (Table 3) requesting the MS information to the adjacent BS, and an MS information response backbone message (Table 4) providing the MS information to the adjacent BS in reply to the adjacent BS's request, and then transmits the messages over the backbone network.

In light of the foregoing, in the multihop relay BWA communication system, if an MS is handed over, the signaling to provide its MS information to the target node is defined to accomplish the optimized network reentry procedure between the MS and the target node. Particularly, by defining the RS-BS signaling to provide the RS with information as to the MS handed over to the RS, the optimized network reentry procedure can be carried out between the RS being the target node and the MS. In other words, by reducing the time taken for the network reentry procedure, the MS handed over to the RS can resume its normal communication more rapidly.

While the invention has been shown and described with reference to certain preferred embodiments thereof, it will be understood by those skilled in the art that various changes in form and details may be made therein without departing from the spirit and scope of the invention as further defined by the appended claims.

What is claimed is:

1. A communication method for a Relay Station (RS) in a multihop relay wireless communication system, the method comprising:
receiving a HO-notify message, which contains information of a Mobile Station (MS) handed over to the RS, from a Base Station (BS); and
performing an optimized network reentry procedure with the MS using the MS information of the HO-notify message.

2. The communication method of claim 1, wherein the HO-notify message includes at least one of identifier (ID) information of the MS, Connection ID (CID) information to be used by the MS, basic capability information supported by the MS, authentication information of the MS, registration information of the MS, and ranging interval allocation time information.

3. The communication method of claim 1, further comprising:
determining whether additional MS information is required in the optimized network reentry procedure;
sending a request message to the BS requesting the MS information, when the additional MS information is required,;
receiving a response message containing the requested MS information from the BS; and
continuing the optimized network reentry procedure using the MS information of the response message.

4. The communication method of claim 3, wherein the request message includes at least one of the MS ID information, information which requests MS basic capability information, information which requests MS authentication information, and information which requests MS registration information.

5. The communication method of claim 3, wherein the response message includes at least one of the MS ID information, the basic capability information supported by the MS, the MS authentication information, and the MS registration information.

6. A communication method for a Relay Station (RS) in a multihop relay wireless communication system, the method comprising;
determining if a former serving node is the RS when receiving a ranging request message containing a former serving node identifier (ID) from a Mobile Station (MS);
sending a request message to a Base Station (BS) requesting MS information, when the former serving node is not the RS;
receiving a response message including the requested MS information from the BS; and
performing an optimized network reentry procedure with the MS using the MS information of the response message.

7. The communication method of claim 6, further comprising:
determining whether there is the MS information when the former serving node is the RS;
sending a request message to the BS, requesting the MS information, when there is no MS information;
receiving a response message including the requested MS information from the BS; and
performing the optimized network reentry procedure with the MS using the MS information of the response message.

8. The communication method of claim 6, wherein the request message includes at least one of MS ID information, information which requests MS basic capability information, information which requests MS authentication information, information which requests MS registration information, and ID information of the former serving node.

9. The communication method of claim 6, wherein the response message includes at least one of the MS ID information, the basic capability information supported by the MS, the MS authentication information, the MS registration information, and Connection Identifier (CID) information to be used by the MS.

10. A communication method for a Base Station (BS) in a multihop relay wireless communication system, the method comprising:
determining if a target node is a Relay Station (RS) managed by the BS when receiving a MOB_HO-IND message indicating handover of a Mobile Station (MS); and
sending to the RS a HO-notify message containing information required for a network reentry procedure of the MS, when the target node is the RS managed by the BS.

11. The communication method of claim 10, wherein the MOB_HO-IND message includes at least one of identifier (ID) information of the MS, Connection ID (CID) information to be used by the MS, basic capability information supported by the MS, authentication information of the MS, registration information of the MS, and ranging interval allocation time information.

12. A communication method for a Base Station (BS) in a multihop relay wireless communication system, the method comprising:
determining if a target node is the BS when receiving a HO-confirm message containing information of a handed Mobile Station (MS) from an adjacent BS; and
sending to the RS a HO-notify message containing information required for a network reentry procedure of the MS when the target node is a Relay Station (RS) managed by the BS.

13. The communication method of claim 12, wherein the HO-notify message includes at least one of identifier (ID) information of the MS, Connection ID (CID) information to be used by the MS, basic capability information supported by the MS, authentication information of the MS, registration information of the MS, and ranging interval allocation time information.

14. The communication method of claim 12, wherein the HO-confirm message includes at least one of ID information of the target node, the MS ID information, the basic capability information supported by the MS, the MS authentication information, the MS registration information, and ranging interval allocation time information of the target node.

15. The communication method of claim 12, further comprising:
performing an optimized network reentry procedure with the MS using the MS information of the HO-confirm message when the target node is the BS;
determining if additional MS information is required in the optimized network reentry procedure;
sending to an adjacent BS a request backbone message requesting the MS information, when the additional MS information is required;
receiving a response backbone message including the requested MS information from the adjacent BS; and
continuing the optimized network reentry procedure with the MS using the MS information of the response backbone message.

16. The communication method of claim 15, wherein the request backbone message includes at least one of the MS ID information, information which requests the basic capability information of the MS, information which requests the MS authentication information, and information which requests the MS registration information.

17. The communication method of claim 15, wherein the response backbone message includes at least one of the MS ID information, the basic capability information supported by the MS, the MS authentication information, and the MS registration information.

18. A communication method of a Base Station (BS) in a multihop relay wireless communication system, the method comprising:
determining if information of an MS managed by the BS is requested when receiving a request message which requests Mobile Station (MS) information required for a network reentry procedure, from a Relay Station (RS),; and
sending a response message containing the requested MS information to the RS when the information of the MS managed by the BS is requested.

19. The communication method of claim 18, further comprising:
transmitting or broadcasting to an adjacent BS or adjacent BSs a request backbone message requesting the MS information, when the MS is not managed by the BS;
receiving a response backbone message including the requested MS information from the adjacent BS; and
sending a response message containing information of the response backbone message to the RS.

20. The communication method of claim 18, wherein the request message includes at least one of identifier (ID) information of the MS, information which requests basic capability information of the MS, information which requests authentication information of the MS, and information which requests registration information of the MS.

21. The communication method of claim 18, wherein the response message includes at least one of the MS ID information, the basic capability information supported by the MS, the MS authentication information, and the MS registration information.

22. A communication method for a Base Station (BS) in a multihop relay wireless communication system, the method comprising:
determining if the former serving node is a node managed by the BS when receiving a ranging request message including a former serving node identifier (ID) from a Mobile Station (MS);
transmitting or broadcasting to an adjacent BS or adjacent BSs a request backbone message requesting the MS information, when the former serving node is not the node managed by the BS;
receiving a response backbone message including the requested MS information from the adjacent BS; and
performing an optimized network reentry procedure with the MS using the information of the response backbone message.

23. The communication method of claim 22, wherein the request backbone message includes at least one of MS ID information, information which requests MS basic capability information, information which requests MS authentication information, information which requests MS registration information, and ID information of the former serving node.

24. The communication method of claim 22, wherein the response backbone message includes at least one of the MS ID information, the basic capability information supported by the MS, the MS authentication information, and the MS registration information.

25. A Relay Station (RS) in a multihop relay wireless system, comprising:
a message processor which, when a HO-notify message is received from a Base Station (BS), extracts information of a Mobile Station (MS) performing handover from the HO-notify message; and
a controller which performs an optimized network reentry procedure with the MS using the information extracted from the HO-notify message.

26. The RS of claim 25, wherein the HO-notify message includes at least one of identifier (ID) information of the MS, Connection ID (CID) information to be used by the MS, basic capability information supported by the MS, authentication information of the MS, registration information of the MS, and ranging interval allocation time information.

27. The RS of claim 25, further comprising:
a message generator which, when additional MS information is required in the optimized network reentry procedure, generates a request message which requests the MS information; and
a transmitter which converts the request message from the message generator according to a prescribed wireless standard and transmits the converted message to the BS,
wherein the controller, when receiving a response message in reply to the request message, performs the optimized network reentry procedure with the MS using information extracted from the response message.

28. The RS of claim 25, wherein the request message includes at least one of MS ID information, information which requests MS basic capability information, information which requests MS authentication information, and information which requests MS registration information.

29. The RS of claim 25, wherein the response message includes at least one of the MS ID information, the basic capability information supported by the MS, the MS authentication information, and the MS registration information.

30. A Relay Station (RS) in a multihop relay wireless system, comprising:
a controller which, when a ranging request message is received from a Mobile Station (MS), determines whether the RS is a former serving node using a former serving node identifier (ID) of the ranging request message;
a message generator which, when the RS is not the former serving node, requests a request message to request the MS information; and
a transmitter which converts the request message from the message generator according to a prescribed wireless standard and transmits the converted message to the BS.

31. The RS of claim 30, further comprising:
a message processor which, when receiving a response message in reply to the request message, extracts the MS information from the response message,
wherein the controller performs an optimized network reentry procedure with the MS using the MS information.

32. The RS of claim 30, wherein the request message includes at least one of MS ID information, information which requests MS basic capability information, information which requests MS authentication information, information which requests MS registration information, and ID information of the former serving node.

33. The RS of claim 30, wherein the response message includes at least one of the MS ID information, the basic capability information supported by the MS, the MS authentication information, the MS registration information, and Connection Identifier (CID) information to be used by the MS.

34. A communication method for a Base Station (BS) in a multihop relay wireless communication system, the method comprising:
determining if a target node is a Relay Station (RS) managed by the BS when receiving a message indicating handover of a Mobile Station (MS);
generating a handover management message, which contains ranging interval allocation time information of the target node when the target node is the RS; and
transmitting the handover management message to the RS.

35. The communication method of claim 34, wherein the ranging interval allocation time information is a value reflecting an action time provided to the MS during handover negotiation.

36. A communication method of a Relay Station (RS) in a multihop relay wireless communication system, the method comprising:
acquiring ranging interval allocation time information of a target node from the handover management message when receiving a handover management message indicating handover of a Mobile Station (MS); and
allocating a contention-free ranging interval to the MS based on the ranging interval allocation time information.

37. The communication method of claim 36, wherein the ranging interval allocation time information is a value reflecting an action time provided to the MS during handover negotiation.

38. The communication method of claim 36, further comprising:
performing an optimized network reentry procedure with the MS using MS information extracted from the handover management message.

39. The communication method of claim 36, wherein the handover management message includes at least one of identifier (ID) information of the target node, MS ID information, basic capability information supported by the MS, MS authentication information, MS registration information, and the ranging interval allocation time information of the target node.
